(19) United States
(12) Patent Application Publication
(10) Pub. No.: US 2003/0193804 A1
(43) Pub. Date: Oct. 16, 2003

(54) Illuminated pole-suspended flag and method of illuminating

(76) Inventor: Karl S. Schroeder, Clayton, OH (US)

Correspondence Address: William Weigl, 1805 Conwood Dr., Troy, OH, 45373, US

(21) Appl. No.: 10/403,141

(22) Filed: Apr. 1, 2003

Related U.S. Application Data
(60) Provisional application No. 60/371,565, filed on Apr. 11, 2002.

(51) Int. Cl. F21V 33/00

(52) U.S. Cl. 362/253; 362/396

(57) ABSTRACT

To enable legal twenty-four hour national flag display, to permit night display of vehicle-mounted school and team flags, and to do either with minimal increase in night sky light pollution, I mount a light source immediately adjacent a flag and direct the light essentially directly toward the flag, rather than upwardly into the sky. Preferably, the light source is provided within a transparent portion of the flag-mounting pole, and is ideally focused directly toward the flag by a reflector which is adapted to shift positions with changes in flag positions due to directional changes of air flow across the flag.

This application is based on U.S. Provisional Patent Application Serial No. 60/371,565 filed Apr. 11, 2002.

This invention relates to flag illumination from immediately adjacent a flag under night or low light conditions, whether such flag is mounted on a stationary flagpole, on a moving vehicle or is hand carried.

### BACKGROUND OF THE INVENTION

Chapter 10 of Title 36 of the United States Code recommends American flag display only from sunrise to sunset. However, it also states that American flags “may be displayed twenty-four hours a day if properly illuminated during hours of darkness”. Flags, particularly national flags and team or school flags, represent a source of pride to those who display them. University flags are frequently quite prominently exhibited on vehicles traveling to and from major sporting events of the school. It is fair to assume that if school flags could be easily and inexpensively lit up after dark, many would opt for the added feature.

Pole-mounted flags present a not-insignificant problem of atmospheric light pollution when the flag is on a tall pole or flagstaff and one or more spotlights at ground level are focused on the flag area surrounding 360 degrees at the top of the pole. According to the International Dark-Sky Association, over one billion dollars is wasted annually to generate light that does nothing more than light up the sky unnecessarily, and create problems while doing so. It is estimated that almost one third of the light created out-of-doors escapes into the night sky where, instead of providing useful illumination, it causes glare, sky glow and other types of light pollution. According to the Dark-Sky Association, about 2,500 individual stars should normally be visible on a clear night in an unpolluted sky, but in a typical suburb, only 200 to 300 may be visible. In a city, fewer than a dozen stars may shine through an artificially lit sky.

While the most common causes of light pollution are street lights, security lights, billboards lit from below, landscape illumination directed upwardly, businesses like convenience stores and gas stations that operate under extremely high levels of illumination, spot lights trained on night-lit flags also contribute to some extent to the overall problem. To combat this, many municipalities and communities, especially those in areas of research observatories, have responded to the urging of astronomers and have enacted ordinances for the regulation of night lighting. Additionally, at the request of wildlife environmental groups, some of Florida's oceanfront communities have adopted lighting codes to protect nesting sea turtles along beaches. These and other problems were taken into account in the development of the present invention. It will be seen that not only does my invention make it easier for people to display the national flag both day and night, but it does so at smaller cost, less bother and greater overall energy savings than comparable flag illumination in the past.

### SUMMARY OF THE INVENTION

To enable legal twenty-four hour national flag display, to permit night display of vehicle-mounted school and team flags, and to do either with minimal increase in night sky light pollution, I mount a light source immediately adjacent a flag and direct the light essentially directly toward the flag, rather than upwardly into the sky. Preferably, the light source is provided within a transparent portion of the flag-mounting pole, and is ideally focused directly toward the flag by a reflector which is adapted to shift positions with changes in flag positions due to directional changes of air flow across the flag.

It is a principal object of the invention to provide for illuminating a flag from immediately adjacent its suspended end with minimal upwardly-directed light pollution of surrounding sky.

More specifically, an object is to concentrate the illumination by providing for reflector-focusing of light from a source thereof directly and essentially radially toward the flag.

A still further object is to maintain light focus directly toward a flag irrespective of airflow directional changes across the flag.

In a pole-mounted flag, an object of the invention is to mount a flag in part on a halyard truck that is pivotal in response to wind direction changes across the flag, and to mount a reflector to pivot in unison with the truck in order to maintain reflected light focus toward the flag at all times.

In a vehicle-mounted flag, an object is to allow for pivotal movement of a flag about its pole and to maintain illumination of the flag in any position to which the flag may move.

More specifically in connection with the immediately-preceding object, it is an object to provide a reflector responsive to flag directional changes to maintain focal direction of illumination toward the flag at all times.

Other objects and advantages will become apparent from the following description, in which reference is made to the accompanying drawings.

### BRIEF DESCRIPTION OF THE DRAWINGS

FIG. 1 is a fragmentary, cross-sectional generally vertical view of a stationary flagpole illustrating its key components.

FIG. 2 is a cross-sectional view taken essentially along lines 2-2 of FIG. 1.

FIG. 3 is a lower cross-sectional view of the flagpole of FIG. 1 at a level a few feet above ground level, illustrating winch mechanism for manually hoisting and lowering a flag as well as mechanism for raising and lowering an internal light source to enable bulb changing when necessary.

FIG. 4 is a cross-sectional fragmentary vertical view of a type of my invention useful for exhibiting a school or team flag atop a vehicle.

FIG. 5 is a cross-sectional view of the flag mount of FIG. 4, and is taken along lines 5-5 of FIG. 4.

### DETAILED DESCRIPTION OF THE PREFERRED EMBODIMENTS

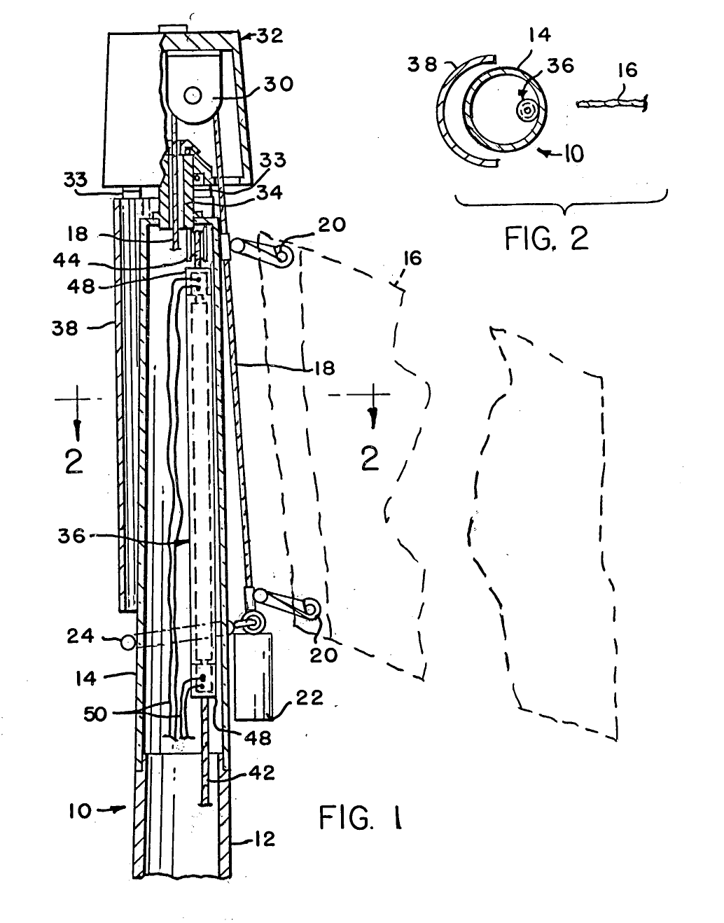

FIG. 1 shows the upper or top section of a permanent flagpole 10 having a metallic tubular portion 12 for its principal length and a transparent plastic tubular portion 14 mounted atop the portion 12. The portion 14 is of a length at least somewhat exceeding the height of a flag 16. Portion 14 securely interfits the portion 12 in a manner providing a smooth continuation of the exterior surface of the two tubular portions. While FIG. 1 shows the flagpole 10 as being vertical and may be referred to in that manner, it should be understood that the flagpole 10 may be angled and may be either ground or building mounted.

The left end of flag 16 is suspended from a line or halyard 18 by any means such as swivel hooks 20 applied to the halyard 18. In addition, a counterweight 22 and a light is thus directed along the flag 16 on both sides thereof from its suspended end adjacent pole 10 toward its free end at the extreme right of FIG. 1. The fluorescent tube may be of a length equal to the height of the flag.

When wind and flag directions change, in order to maintain light focus, it is necessary to have reflector 38 keep a constant diametrically-opposite relationship with that of the flag 16. In the illustrated embodiment, I best accomplish this by securing the reflector 38 to depend downwardly from the revolving truck 32 by means of brackets 33. As the flag responds to a change in wind direction, it pivots the pulley system 30 and truck 32 with it about the axle 34. Being directly affixed to the truck, the reflector 38 likewise moves about pole 10 to the same extent as flag 16.

For lowest energy cost and longest life of the light source, it is preferably automatically activated to its “on” condition only under low light conditions by customary light-sensitive switching controls (not shown). It will also be seen that the light direction is generally horizontally toward the flag, and not projected upwardly into the night sky as is common when illuminating a flag from ground-positioned spotlights.

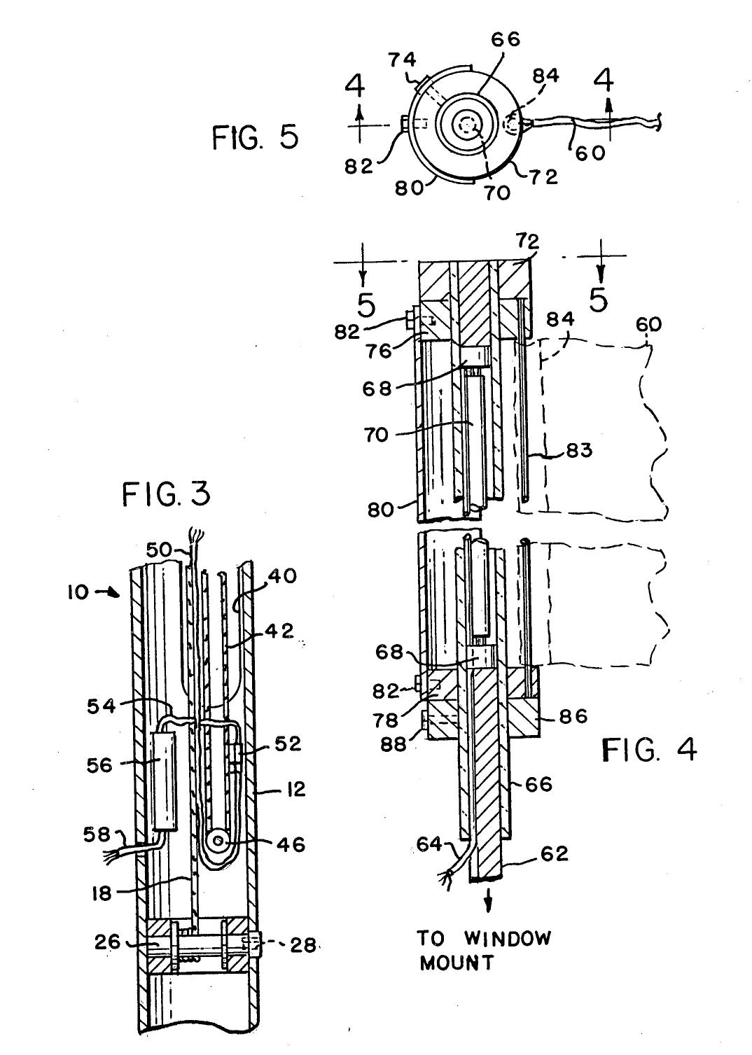

Because the bulb of light source 36 must be replaced occasionally, I provide for moving the light source 36 between its active position shown in FIG. 1 and a replacement position adjacent the winch spool 26 at ground level, as shown in FIG. 3. An elongated opening 40 with a removable cover plate (not shown) is provided for installing and removing the fluorescent tube from a continuous loop cable 42 trained over a pulley 44 at the top in FIG. 1 and a corresponding pulley 46 in FIG. 3. The fluorescent tube can have its opposed tube-receiving sockets 48 mounted to cable 42 in any fashion which maintains their respective positions and distance firmly for securing the tube in place on the cable. Electrical wiring 50 travels with the tube when moved along the cable 42. Assuming the tube 36 is to be replaced, the cover plate over the opening 40 is first removed to gain access to the interior of the pole 10. A plug section 52 connected to wiring 54 is then disconnected from a mating plug section connected to wiring 50. The wiring 54 leads to a ballast 56 connected by wiring 58 to a source of electricity. Once plug 52 is disconnected, the cable 42 can be manually pulled down on the side containing the fluorescent tube. One end of plug 52 attached to wiring 50 is secured to the cable 42 and it and its wiring 50 move upwardly to follow cable 42 as the light source 36 is lowered. Upon fluorescent tube replacement through the opening 40, the cable is manually pulled on its opposite side to raise the new light source into position adjacent the flag. At the same time, the mating section that connects with the plug 52 is lowered back to the position of FIG. 3. The wiring 54 can be reattached to wiring 50 at the plug 52, the opening 40 closed and the entire system is now back in operation with a new light source. The wiring 58 may be connected to a photosensitive switch to energize the light source under conditions when needed. It can be seen that the flag 16 may be exhibited on a permanent basis, so long as the light source 36 remains in working condition. The need and time required for daily raising and lowering the flag is obviated. The United States Code recommends that the flag not be displayed when weather is inclement. Also, if for any reason the flag must be lowered for replacement due to tearing or weather shredding, lowering can be accomplished without affecting the flag illumination system. The two systems are totally independent. If desired, controls can be added to make the lighting system ineffective whenever the flag has been lowered or removed. 76 and 78. The flag 60 is preferably provided at its suspended end with a full-height loop 84 in which a rod 83 is received. Rod 83 is secured at its top and bottom to rotatable collars 76 and 78 respectively. A lower collar 84 is secured to the transparent tube 66 by means of a screw or screws 88. The rotatable 78 collar rests against the upper surface of the lower collar 88. Enough play should be allowed to enable free rotation of the flag 60 and its associated movable parts about tube 66. It is apparent that air flow direction changes across the flag 60 will cause the rod 83 to move circumferentially about the axis of the tube 66. In so doing, the collars 76 and 78 and the reflector 80 follow the rod 83 movement and maintain light focus from the tube 70 toward the flag 60, irrespective of the angular repositioning of the flag 60 about tube 66.

It is feasible to adapt the principles disclosed herein into flags that are manually carried as well as those that are permanent or carried by a moving vehicle. Various other changes may be made in the design details without departing from the spirit and scope of the claims.

Having described my invention, I claim:

1. A device for illuminating a flag under low-light conditions, comprising:
a. a generally tubular pole at least a portion of which is light-transmitting:
b. a light source mounted internally of said pole;
c. a flag having a suspended end adjacent said transparent portion and a free end remote from the suspended end, said flag being freely movable generally circumferentially about said pole;
d. a rotatable element for mounting at least a portion of the suspended end; and
e. said flag extending essentially in a radial direction toward a downwind side of said pole in response to air flow across said pole.

2. A device according to claim 1, further including a light-reflecting element operatively associated with said rotatable element to rotate therewith whereby said light-reflecting element continuously focuses light toward said flag irrespective of air flow direction changes that may cause the flag to move about said pole.

3. A device according to claim 1 wherein said light-transmitting pole portion extends for at least the height dimension of said flag.

4. A device according to claim 3 wherein said light source comprises an elongated tubular element essentially of a length generally equal to the height dimension of said flag.

5. A device according to claim 2 wherein said light-reflecting element is mounted at the exterior of said light-transmitting pole portion.

6. A device according to claim 5 wherein said light source comprises an elongated tubular element essentially of a length generally equal to the height dimension of said flag.

7. A device according to claim 6 wherein said pole is permanently ground-mounted and extends higher than the reach of a person at ground level, and wherein said light source is supported internally of said pole and is mounted on a conveying cable that is capable of raising and lowering said light source relative to said ground level and the position at which said flag is displayed.

8. A device according to claim 7 wherein an access opening is provided in said pole adjacent the ground level to enable light source replacement, and means adjacent the access opening for electrically connecting and disconnecting said light source relative to a fixed ground level supply of electricity.

9. A device according to claim 1 wherein said pole is portable and mountable atop a passenger road vehicle.

10. A device according to claim 9 wherein said pole is window-mountable and said light source is electrically connectable with a dashboard cigar lighter of said vehicle.

11. A device according to claim 9 wherein said light-transmitting pole portion supports a pair of vertically-spaced freely rotatable collars, and wherein a rod extending between and affixing said collars to each other suspends said flag therefrom.

12. A device according to claim 11 wherein a semi-cylindrical light reflector interconnects said freely-rotatable collars diametrically-opposite to said rod whereby to maintain light-directing focus toward said flag irrespective of its rotational position about said light-transmitting pole portion.

13. The method of illuminating an airflow-affected flag having a free end and a suspended end during low light conditions, said method comprising the steps of:
supporting said suspended end from a pole and from a member that is mounted for rotation about an axis parallel to the pole and said suspended end;
utilizing air flow in line with said flag to rotate said member whereby to maintain a predetermined relationship of said member with said flag in response to directional changes in air flow;
providing a light source essentially along the axis to illuminate the suspended end for essentially the length thereof;
focusing light from said light source toward said flag; and
maintaining illumination focus toward the flag free end whenever rotation of the flag-supporting member is caused by changes in air flow direction.

14. A method according to claim 13 including the further steps of providing a light-reflecting surface on that side of the pole diametrically-opposite said flag, moving said surface with said flag in response to air flow direction changes, and wherein said focusing includes reflecting light back across said light source toward said flag to enhance illumination thereof.
